(19) United States
(12) Patent Application Publication
(10) Pub. No.: US 2024/0026767 A1
(43) Pub. Date: Jan. 25, 2024

(54) METHOD AND SYSTEM FOR DETERMINING WELL SPACING FOR IN-SITU LEACHING MINING OF HIGH-PERMEABILITY SANDSTONE-TYPE URANIUM/COPPER DEPOSIT

(71) Applicant: Beijing Research Institute of CH.E. and Metall., Beijing (CN)

(72) Inventors: Xuebin Su, Beijing (CN); Meifang Chen, Beijing (CN); Yihan Yang, Beijing (CN); Yufeng Cui, Beijing (CN); Mingtao Jia, Beijing (CN); Yongguo Xing, Beijing (CN); Weimin Que, Beijing (CN); Zhiming Du, Beijing (CN); Lixin Zhao, Beijing (CN); Yahui Tan, Beijing (CN); Zhaokun Li, Beijing (CN); Zhenqian Wen, Beijing (CN); Zhengbang Liu, Beijing (CN); Ying Xu, Beijing (CN); Chuanfei Zhang, Beijing (CN); Yu Feng, Beijing (CN); Tingting Xie, Beijing (CN); Ruyi Wang, Beijing (CN); Daye Liang, Beijing (CN)

(21) Appl. No.: 18/356,889

(22) Filed: Jul. 21, 2023

(30) Foreign Application Priority Data
Jul. 22, 2022 (CN) 202210866079.0

(51) Int. Cl. E21B 43/30; E21B 43/28; E21B 47/04; E21B 49/00

(52) U.S. Cl. CPC E21B 43/30; E21B 43/28; E21B 47/04; E21B 49/00

(57) ABSTRACT

The present disclosure relates to a method and a system for determining a well spacing for in-situ leaching mining of a high-permeability sandstone-type uranium/copper deposit. The method includes: constructing a three-dimensional geological model of a sandstone reservoir in a mining region, constructing a spatially-discretized volume element model, a lithology model and a grade model of the sandstone reservoir, and obtaining a fused space model; adding drilling engineering in the fused space model, and setting filter parameters of a pump well and an injection well; carrying out solute particle transport simulation computation on the injection well and the pump well, computing well spacing related parameters; obtaining a current well spacing, and continuously carrying out solute particle transport simulation computation until the current well spacing exceeds a set threshold, and drawing relation curves according to a plurality of groups of well spacing related parameters, so as to determine an optimal well spacing.

### CROSS REFERENCE TO RELATED APPLICATION

This patent application claims the benefit and priority of Chinese Patent Application No. 202210866079.0, filed with the China National Intellectual Property Administration on Jul. 22, 2022, the disclosure of which is incorporated by reference herein in its entirety as part of the present application.

### TECHNICAL FIELD

The present disclosure relates to the technical field of ore mining, and particularly to a method and a system for determining a well spacing for in-situ leaching mining of a high-permeability sandstone-type uranium/copper deposit.

### BACKGROUND

An in-situ leaching uranium mining technology for a sandstone-type uranium deposit has become a prevailing production process for natural uranium mining and metallurgy in China. By the end of 2021, an in-situ leaching capacity accounts for 90% or above of a total capacity of domestic natural uranium. The in-situ leaching uranium mining technology has been developed over the past three decades and unceasingly consummates in China, but few of researches are made on arrangement optimization of an in-situ leaching uranium mining well pattern.

During in-situ leaching uranium mining, well pattern arrangement includes arrangement modes (which generally include a determinant mode or a grid mode) of wells and a well spacing in a sandstone-type uranium deposit exploration mining region. Since the well pattern plays a vital role in in-situ leaching uranium mining production, its selection and arrangement determine a production scale and mining life of an in-situ leaching uranium mine and an economic benefit of an in-situ leaching mine enterprise to a great extent. For many years of in-situ leaching uranium mining in China, regardless of permeability of a sandstone-type uranium deposit, a well spacing is generally 25 m-35 m. For example, in a uranium deposit in the songliao basin, an ore-bearing aquifer has a permeability coefficient K=0.025 m/d-0.233 m/d, with an average of 0.10 m/d, an ore-bearing layer has an average thickness of 35 m, a ratio of a thickness of an ore body to a thickness of an ore-bearing layer is 1:4.5, and well spacings are 30 m and 35 m. In a uranium deposit in the erlian basin, an ore-bearing laver has a permeability coefficient K=2.9 m/d-9.5 m/d, and 13 m/d in some regions, with an average of 7 m/d, an ore-bearing layer has an average thickness of 60 m, a ratio of a thickness of an ore body to a thickness of an ore-bearing layer is 1:10, and well spacings are 27 m, 30 m and 35 m. In a uranium deposit in the yili basin, an ore-bearing layer has a permeability coefficient K=0.32 m/d-0.37 m/d, with an average of 0.35 mid, an ore-bearing layer has an average thickness of 12.6 m, a ratio of a thickness of an ore body to a thickness of an ore-bearing layer is 1:3, and well spacings are 25 m, 27 m and 30 m. The well spacing is generally determined according to an indoor long-distance leaching test, a field condition test and previous mining experience in a mining region, without rigorous mathematical arguments.

In the aspect of oil mining, there are numerous researches on well pattern density and a critical well spacing. A development period of an oilfield is relatively long (15 years-40 years), a well spacing is relatively great (500 m-1500 m) in an initial stage of mining, and an infilled well pattern may be used in a later stage of mining. In the case of a low-permeability oilfield, a method for determining a critical well spacing on the basis of low permeability is constructed. Specifically, by means of a computation model of a critical well spacing described by a critical driving pressure between injection and production wells, permeability, a formation pressure, an effective thickness of an oil layer and viscosity, critical well spacings of reservoirs having different permeability under the conditions of different injection and production pressure differences can be computed. An in-situ leaching uranium mining process involves not only seepage of a fluid in a porous medium, but also chemical dissolution, migration, redeposition and other processes in a flow process of a leaching agent, which is different from petroleum mining in terms of permeability of a sandstone reservoir, a uranium mining process, mining life and economy. Therefore, a method for determining a critical well spacing for petroleum is not suitable for in-situ leaching development of a sandstone-type uranium deposit.

In the in-situ leaching uranium mining process, leaching effects of ore bodies vary enormously in the cases of different well spacings. If the well spacing is too large, an injected leaching agent has a wide influence range, useless consumption acting on minerals on a non-ore layer is large, full use of uranium resources is difficult, and a final recovery rate is low. If the well spacing is reduced, a majority of the injected leaching agent can be recovered by a pump well, a leaching speed is fast, a leaching period is shortened, but drilling investment is large, and economy is difficult to guarantee. Selection of the well spacing is affected by development laws of lithology and lithofacies, a shape, a strike, a scale and a burial depth of an ore body, thicknesses of the ore body and an ore-bearing layer, permeability and water abundance of the ore-bearing layer, leachability of ore, pump and injection capacities in a production process, a production scale and economic investment of a mine enterprise. Generally speaking, when the well spacing is designed, if an ore body has a great thickness, and a ratio of ore to sand is great, the well spacing can be increased, and otherwise, the well spacing should be less. The well spacing should be greater in terms of a drilling ore-controlling area and ore body mining investment, and should be less in terms of a coverage rate of a leaching agent and an effective leaching area. Therefore, it is a relatively complex optimization problem to reasonably design well spacings for different types of sandstone-type uranium deposits.

In order to solve the above problems, when a high-permeability sandstone-type uranium deposit is developed through a current in-situ leaching uranium mining technology, there are “two high and two low” problems, that is, high drilling investment, high power consumption during production, a low effective utilization rate of a leaching agent, and a low uranium concentration of a leachate in a mining region. The most direct technical measure to solve the “two high and two low” problems is to optimize a mining well spacing. Therefore, a method for determining a well spacing for in-situ leaching mining of a high-permeability sandstone-type uranium deposit is urgently required.

### SUMMARY

An objective of the present disclosure is to provide a method and system for determining a well spacing for in-situ leaching mining of a high-permeability sandstone-type uranium/copper deposit, which can reduce dilution of a leaching agent, improve a utilization rate of the leaching agent and reduce drilling investment for ore body development.

In order to realize the above objective, the present disclosure provides a technical solution as follows:

The present disclosure provides a method for determining a well spacing for in-situ leaching mining of a high-permeability sandstone-type uranium/copper deposit. The method includes:
obtaining borehole data of a sandstone-type deposit, and constructing a refined three-dimensional geological model of a sandstone reservoir of a target mining region according to the borehole data; where the borehole data includes borehole coordinates, a borehole depth, ore body lithology division information and ore body grade information;
discretizing the target mining region into a regular cuboid set in a three-dimensional space, so as to construct a spatially-discretized volume element model of the sandstone reservoir; setting lithology of each regular cuboid under the constraint of the refined three-dimensional geological model of the sandstone reservoir, so as to determine a lithology model of the sandstone reservoir; and determining a uranium/copper grade of each regular cuboid according to the lithology of each regular cuboid, so as to construct a grade model of uranium/copper in a sandstone reservoir space;
fusing the volume element model, the lithology model and the grade model, so as to obtain a fused space model containing multi-source information of the sandstone reservoir;
determining an initial well spacing according to a ratio of a thickness of an ore body to a thickness of an ore-bearing layer and a permeability coefficient of the sandstone reservoir, and adding drilling engineering on the fused space model according to the initial well spacing; where the drilling engineering includes a pump well and an injection well;
setting filter parameters of the pump well and the injection well on the fused space model according to a position and a thickness of the ore body in the target mining region; where the filter parameters include an opening position and a length of a filter;
carrying out solute particle transport simulation computation on the injection well and the pump well, carrying out statistical analysis on solute particle transport simulation computation results, and computing well spacing related parameters according to statistical results; where the solute particle transport simulation computation results include a number of particles flowing through an ore layer, a number of particles flowing through a non-ore layer and a number of particles recovered through the pump well; and the well spacing related parameters include a particle recovery rate, an effective particle utilization rate and a dilution ratio; and
progressively increasing the initial well spacing on the basis of the fused space model according to a set step length to obtain a current well spacing, continuously carrying out solute particle transport simulation computation, stopping computation until the current well spacing exceeds a set threshold, obtaining a plurality of groups of well spacing related parameters, drawing relation curves according to the plurality of groups of well spacing related parameters, and determining an optimal well spacing according to the relation curves.

Alternatively, the obtaining borehole data of a sandstone-type deposit, and the constructing a refined three-dimensional geological model of a sandstone reservoir of a target mining region according to the borehole data specifically include:
preprocessing the borehole data, and constructing the refined three-dimensional geological model of the sandstone reservoir of the target mining region through an implicit modeling method based on a mathematical interpolation.

Alternatively, the determining an initial well spacing according to a ratio of a thickness of an ore body to a thickness of an ore-bearing layer and a permeability coefficient of the sandstone reservoir specifically includes:
setting L₀=15 m under the conditions of K=1 m/d-5 m/d and P<1:3; and
setting L₀=20 m under the condition of K≥5 m/d or P>1:3; where
K is the permeability coefficient of the sandstone reservoir, P is the ratio of the thickness of the ore body to the thickness of the ore-bearing layer, and L₀ is the initial well spacing.

Alternatively, the setting filter parameters of the pump well and the injection well on the fused space model according to a position and a thickness of the ore body in the target mining region specifically includes:
setting, under the condition that the ore body has a thickness greater than 10 m, positions of filters of the pump well and the injection well on the basis of a central position of the ore body, a length of the filter of the pump well 0.8 time the thickness of the ore body, and a length of the filter of the injection well 0.6 time the thickness of the ore body; and
setting, under the condition that the ore body has a thickness less than 10 m, positions of filters of the pump well and the injection well on the basis of a central position of the ore body, a length of the filter of the pump well 0.9 time the thickness of the ore body and not less than 4 m, and a length of the filter of the injection well 0.6 time the thickness of the ore body and not less than 3 m.

Alternatively, the carrying out solute particle transport simulation computation on the injection well and the pump well specifically includes:
setting a flow rate of the pump well, a flow rate of the injection well, a total number of particles injected through the injection well and a number of days of simulation computation on the basis of permeability and groundwater pressure-bearing performance of the target mining region, so as to complete solute particle transport simulation computation.

Alternatively, the computing well spacing related parameters according to statistical results specifically includes:
computing a ratio of a number of particles recovered through the pump well to a total number of particles injected through the injection well, so as to obtain the particle recovery rate;
computing a ratio of a number of particles flowing through the ore layer to a total number of particles injected through the injection well, so as to obtain the effective particle utilization rate; and
computing a ratio of a number of particles flowing through the non-ore layer to a number of particles recovered through the pump well, so as to obtain the dilution ratio.

In order to realize the above objective, the present disclosure further provides a solution as follows:
a system for determining a well spacing for in-situ leaching mining of a high-permeability sandstone-type uranium/copper deposit includes:
a data obtainment and refined three-dimensional geological model construction unit configured to obtain borehole data of a sandstone-type deposit, and construct a refined three-dimensional geological model of a sandstone reservoir of a target mining region according to the borehole data; where the borehole data includes borehole coordinates, a borehole depth, ore body lithology division information and ore body grade information;
a volume element model, lithology model and grade model construction unit configured to discretize the target mining region into a regular cuboid set in a three-dimensional space, so as to construct a spatially-discretized volume element model of the sandstone reservoir; set lithology of each regular cuboid under the constraint of the refined three-dimensional geological model of the sandstone reservoir, so as to determine a lithology model of the sandstone reservoir; and determine a uranium/copper grade of each regular cuboid according to the lithology of each regular cuboid, so as to construct a grade model of uranium/copper in a sandstone reservoir space;
a fused space model construction unit configured to fuse the volume element model, the lithology model and the grade model, so as to obtain a fused space model containing multi-source information of the sandstone reservoir;
an initial well spacing determination and drilling engineering addition unit configured to determine an initial well spacing according to a ratio of a thickness of an ore body to a thickness of an ore-bearing layer and a permeability coefficient of the sandstone reservoir, and add drilling engineering on the fused space model according to the initial well spacing; where the drilling engineering includes a pump well and an injection well;
a filter parameter setting unit configured to set filter parameters of the pump well and the injection well on the fused space model according to a position and a thickness of the ore body in the target mining region; where the filter parameters include an opening position and a length of a filter;
a solute particle transport simulation computation, statistical analysis and well spacing related parameter computation unit configured to carry out solute particle transport simulation computation on the injection well and the pump well, carry out statistical analysis on solute particle transport simulation computation results, and compute well spacing related parameters according to statistical results; where the solute particle transport simulation computation results include a number of particles flowing through an ore layer, a number of particles flowing through a non-ore layer and a number of particles recovered through the pump well; and the well spacing related parameters include a particle recovery rate, an effective particle utilization rate and a dilution ratio; and
an optimal well spacing determination unit configured to progressively increase the initial well spacing on the basis of the fused space model according to a set step length to obtain a current well spacing, continuously carry out solute particle transport simulation computation, stop computation until the current well spacing exceeds a set threshold, obtain a plurality of groups of well spacing related parameters, draw relation curves according to the plurality of groups of well spacing related parameters, and determine an optimal well spacing according to the relation curves.

According to particular embodiments provided in the present disclosure, the present disclosure discloses technical effects as follows:

A method and system for determining a well spacing for in-situ leaching mining of a high-permeability sandstone-type uranium/copper deposit are provided in the present disclosure. The method includes: constructing a refined three-dimensional geological model of a sandstone reservoir of a target mining region according to borehole data of a sandstone-type deposit; constructing a spatially-discretized volume element model of the sandstone reservoir, a lithology model and a grade model of uranium/copper in a sandstone reservoir space, and fusing the volume element model, the lithology model and the grade model, so as to obtain a fused space model containing multi-source information of the sandstone reservoir; adding drilling engineering on the fused space model according to an initial well spacing, and setting filter parameters of a pump well and an injection well on the fused space model according to a position and a thickness of an ore body in the target mining region; carrying out solute particle transport simulation computation on the injection well and the pump well, carrying out statistical analysis on solute particle transport simulation computation results, and computing well spacing related parameters; and progressively increasing the initial well spacing on the basis of the fused space model according to a set step length to obtain a current well spacing, continuously carrying out solute particle transport simulation computation, stopping computation until the current well spacing exceeds a set threshold, obtaining a plurality of groups of well spacing related parameters, drawing relation curves according to the plurality of groups of well spacing related parameters, and determining an optimal well spacing according to the relation curves. According to the present disclosure, an optimization design of a well spacing during in-situ leaching mining of a high-permeability sandstone-type uranium/copper deposit has advantages of improving utilization efficiency of a leaching agent, reducing dilution of the leaching agent, and reducing drilling investment for ore body development.

### BRIEF DESCRIPTION OF THE DRAWINGS

In order to describe technical solutions in embodiments of the present disclosure or in the prior art more clearly, accompanying drawings required to be used in the embodiments will be briefly introduced below. Apparently, the accompanying drawings in the following description show merely some embodiments of the present disclosure, and those of ordinary skill in the art can derive other accompanying drawings from these accompanying drawings without creative efforts.

FIG. 1 is a flow diagram of a method for determining a well spacing for in-situ leaching mining of a high-permeability sandstone-type uranium/copper deposit according to the present disclosure:

FIG. 2 is a modular schematic structural diagram of a system for determining a well spacing for in-situ leaching mining of a high-permeability sandstone-type uranium/copper deposit according to the present disclosure:

FIG. 3 is a schematic arrangement diagram of an ore-bearing aquifer and boreholes according to a particular embodiment of the present disclosure,

FIG. 4 shows statistical data of transported particles under the condition that a filter penetrates an ore layer according to a particular embodiment of the present disclosure;

FIG. 5 shows statistical data of transported particles under the condition that a length of a filter is limited according to a particular embodiment of the present disclosure;

FIG. 6 is a flow field simulation diagram in the case of a less well spacing according to a particular embodiment of the present disclosure;

FIG. 7 is a flow field simulation diagram in the case of an increased well spacing according to a particular embodiment of the present disclosure; and

FIG. 8 shows relation curves between well spacing related parameters and well spacings drawn according to a particular embodiment of the present disclosure.

### DESCRIPTION OF REFERENCE NUMERALS

data obtainment and refined three-dimensional geological model construction unit-1, volume element model, lithology model and grade model construction unit-2, fused space model construction unit-3, initial well spacing determination and drilling engineering addition unit-4, filter parameter setting unit-5, solute particle transport simulation computation, statistical analysis and well spacing related parameter computation unit-6, and optimal well spacing determination unit-7.

### DETAILED DESCRIPTION OF THE EMBODIMENTS

Technical solutions of embodiments of the present disclosure will be clearly and completely described below in combination with accompanying drawings in the embodiments of the present disclosure. Apparently, the described embodiments are merely some embodiments rather than all embodiments of the present disclosure. All other embodiments derived by those of ordinary skill in the art on the basis of embodiments of the present disclosure without creative efforts all fall within the scope of protection of the present disclosure.

An objective of the present disclosure is to provide a method and system for determining a well spacing for in-situ leaching mining of a high-permeability sandstone-type uranium/copper deposit, which can reduce dilution of a leaching agent, improve a utilization rate of the leaching agent and reduce drilling investment for ore body development.

In order to make the above objective, features and advantages of the present disclosure clearer and more comprehensible, the present disclosure will be further described in detail below in combination with accompanying drawings and particular implementation modes.

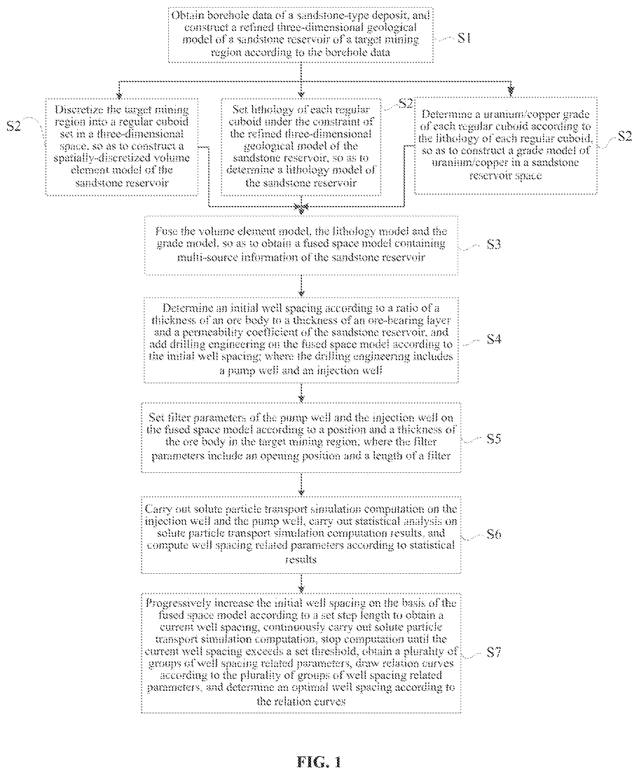

As shown in FIG. 1, a method for determining a well spacing for in-situ leaching mining of a high-permeability sandstone-type uranium/copper deposit in the present disclosure includes:
S1: Obtain borehole data of a sandstone-type deposit, and construct a refined three-dimensional geological model of a sandstone reservoir of a target mining region according to the borehole data; where the borehole data includes borehole coordinates, a borehole depth, ore body lithology division information and ore body grade information.
S2: Discretize the target mining region into a regular cuboid set in a three-dimensional space, so as to construct a spatially-discretized volume element model of the sandstone reservoir; set lithology of each regular cuboid under the constraint of the refined three-dimensional geological model of the sandstone reservoir, so as to determine a lithology model of the sandstone reservoir; and determine a uranium/copper grade of each regular cuboid according to the lithology of each regular cuboid, so as to construct a grade model of uranium/copper in a sandstone reservoir space. The lithology model includes lithology distribution information of coarse sandstone, medium sandstone, fine sandstone, etc., and space distribution information of a top plate and a bottom plate.
S3: Fuse the volume element model, the lithology model and the grade model, so as to obtain a fused space model containing multi-source information of the sandstone reservoir.
S4: Determine an initial well spacing according to a ratio of a thickness of an ore body to a thickness of an ore-bearing layer and a permeability coefficient of the sandstone reservoir, and add drilling engineering on the fused space model according to the initial well spacing; where the drilling engineering includes a pump well and an injection well. Engineering data is added in a COMSOL software module and engineering is directly added.
S5: Set filter parameters of the pump well and the injection well on the fused space model according to a position and a thickness of the ore body in the target mining region; where the filter parameters include an opening position and a length of a filter.
S6: Carry out solute particle transport simulation computation on the injection well and the pump well, carry out statistical analysis on solute particle transport simulation computation results, and compute well spacing related parameters according to statistical results; where the solute particle transport simulation computation results include a number (M_{K}) of particles flowing through an ore layer, a number (M_{F}) of particles flowing through a non-ore layer and a number (M_{C}) of particles recovered through the pump well; and the well spacing related parameters include a particle recovery rate, an effective particle utilization rate and a dilution ratio.
S7: Progressively increase the initial well spacing on the basis of the fused space model according to a set step length to obtain a current well spacing, continuously carry out solute particle transport simulation computation, stop computation until the current well spacing exceeds a set threshold, obtain a plurality of groups of well spacing related parameters, draw relation curves according to the plurality of groups of well spacing related parameters, and determine an optimal well spacing according to the relation curves.

A high-permeability sandstone reservoir refers to a sandstone reservoir having a permeability coefficient (K)≥1 m/d.

The particles refer to particles in simulation computation software.

Further, the step S1 of obtaining borehole data of a sandstone-type deposit, and constructing a refined three-dimensional geological model of a sandstone reservoir of a target mining region according to the borehole data specifically includes:
preprocess the borehole data, and construct the refined three-dimensional geological model of the sandstone reservoir of the target mining region through an implicit modeling method based on a mathematical interpolation. The borehole data comes from an exploration stage of an ore deposit, and after being preprocessed, the borehole data is stored in a data file format that may be identified by three-dimensional geological modeling software. LeapFrog, earth volumetric studio (EVS) and other software are used for three-dimensional geological modeling.

Further, the step S4 of determining an initial well spacing according to a ratio of a thickness of an ore body to a thickness of an ore-bearing layer and a permeability coefficient of the sandstone reservoir specifically includes:
set L₀=15 m under the conditions of K=1 m/d-5 m/d and P<1:3; where the well spacing for in-situ leaching mining is generally not less than 15 m in consideration of economy; and
set L₀=20 m under the condition of K≥5 m/d or P>1:3; where
K is the permeability coefficient of the sandstone reservoir, P is the ratio of the thickness of the ore body to the thickness of the ore-bearing layer, and L₀ is the initial well spacing.

Further, the step S5 of setting filter parameters of the pump well and the injection well on the fused space model according to a position and a thickness of the ore body in the target mining region specifically includes:
set, under the condition that the ore body has a thickness greater than 10 m, positions of filters of the pump well and the injection well on the basis of a central position of the ore body, a length of the filter of the pump well 0.8 time the thickness of the ore body, and a length of the filter of the injection well 0.6 time the thickness of the ore body; and
set, under the condition that the ore body has a thickness less than 10 m, positions of filters of the pump well and the injection well on the basis of a central position of the ore body, a length of the filter of the pump well 0.9 time the thickness of the ore body and not less than 4 m, and a length of the filter of the injection well 0.6 time the thickness of the ore body and not less than 3 m.

Further, the step S6 of carrying out solute particle transport simulation computation on the injection well and the pump well specifically includes:
set a flow rate of the pump well, a flow rate of the injection well, a total number (M_{Z}) of particles injected through the injection well and a number (D) of days of simulation computation on the basis of permeability and groundwater pressure-bearing performance of the target mining region, so as to complete solute particle transport simulation computation.

Generally, about 5000-10000 particles are injected in total through the injection well. The more the particles, the higher the requirement for computation performance of a computer, and the longer the computation time of transport simulation, but the more the particles, the better the stability of a computation result. According to computation experience in a plurality of examples, 5000 particles may satisfy the requirements. Under the condition that a sandstone reservoir has a permeability coefficient K=1 m/d-5 m/d, a number of days is set as 30, and the computation result is quite stable. In order to ensure better stability, a number of days may be set as 60.

Statistical analysis may be carried out on solute particle transport simulation computation results by a statistical mini program compiled in python language, which specifically includes:
1. Define the following sets first with python dictionaries, which specifically include:
Particle_Set_Ore, a set of particles flowing through an ore layer;
Particle_Set_Rock, a set of particles flowing through a non-ore layer; and
Particle_Set_Prod, a set of particles recovered through a pump well.
2. Carry out a statistical algorithm, which may be divided into three steps:
(1) initialize elements in the Particle_Set_Ore, the Particle_Set_Rock and the Particle_Set_Prod, and a number D of days of simulation; where dictionaries of the Particle_Set_Ore and the Particle_Set_Rock contain all particle information released in corresponding regions, and no element information is in a dictionary of the Particle_Set_Prod.
(2) For all d∈D do: (each number of days of operation is within set simulation time)
write extracted particle information into the dictionary of the Particle_Set_Prod;
update data of the dictionaries of the Particle_Set_Ore and the Particle_Set_Rock; and
carry out statistical analysis on a number of particles from the ore layer and the non-ore layer in the pump well every day.
(3) Draw distribution curves, where
the distribution curves are used for visually determining whether a simulation computation process tends to be stable.

Further, the step S6 of computing well spacing related parameters according to statistical results specifically includes:

After ith simulation computation, compute a ratio of a number of particles recovered through the pump well to a total number of particles injected through the injection well, so as to obtain the particle recovery rate (B1ᵢ).

Compute a ratio of a number of particles flowing through the ore layer to a total number of particles injected through the injection well, so as to obtain the effective particle utilization rate (B2ᵢ).

Compute a ratio of a number of particles flowing through the non-ore layer to a number of particles recovered through the pump well, so as to obtain the dilution ratio (B3ᵢ), and finally output a group of obtained data [B1ᵢ,B2ᵢ,B3ᵢ].

i=[1, . . . ,integer of (Lₘₐₓ−L₀)/2.5]; and

Lₘₐₓ is a maximum set well spacing, and under the conditions of K=1 m/d-5 m/d and P<1:3, Lₘₐₓ=60 m may be set; and under the condition of K≥5 m/d or P>1:3, Lₘₐₓ=80 m may be set.

Finally, adjust a well spacing (Lᵢ) on the fused space model, and progressively increase the well spacing by 2.5 m on the basis of a previous model. That is, Lᵢ=Lᵢ₋₁+2.5. Then, sequentially repeat steps S6 and S7. Specifically, under the condition of Lᵢ<a set value (Lₘₐₓ), return to step S6 and continue to execute step S7. Under the condition of Lᵢ≥a set value (Lₘₐₓ), jump out of the loop, stop computation, obtain a plurality of groups of well spacing related parameter |B1ᵢ|, [B2ᵢ] and |B3ᵢ|, draw relation curves between well spacings (Lᵢ) and particle recovery rates (Lᵢ), and relation curves between effective particle utilization rates (B2ᵢ) and dilution ratios (B3ᵢ), and determine an optimal well spacing, that is, a well spacing which is reasonable in technology and economy of ore body development, according to inflection points of the relation curves.

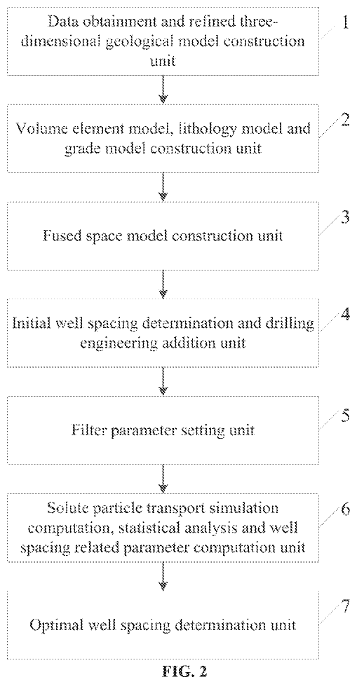

Further, as shown in FIG. 2, the present disclosure further provides a system for determining a well spacing for in-situ leaching mining of a high-permeability sandstone-type uranium/copper deposit. The system includes: a data obtainment and refined three-dimensional geological model construction unit 1, a volume element model, lithology model and grade model construction unit 2, a fused space model construction unit 3, an initial well spacing determination and drilling engineering addition unit 4, a filter parameter setting unit 5, a solute particle transport simulation computation, statistical analysis and well spacing related parameter computation unit 6, and an optimal well spacing determination unit 7.

The data obtainment and refined three-dimensional geological model construction unit 1 is configured to obtain borehole data of a sandstone-type deposit, and construct a refined three-dimensional geological model of a sandstone reservoir of a target mining region according to the borehole data where the borehole data includes borehole coordinates, a borehole depth, ore body lithology division information and ore body grade information.

The volume element model, lithology model and grade model construction unit 2 is configured to discretize the target mining region into a regular cuboid set in a three-dimensional space, so as to construct a spatially-discretized volume element model of the sandstone reservoir; set lithology of each regular cuboid under the constraint of the refined three-dimensional geological model of the sandstone reservoir, so as to determine a lithology model of the sandstone reservoir; and determine a uranium/copper grade of each regular cuboid according to the lithology of each regular cuboid, so as to construct a grade model of uranium/copper in a sandstone reservoir space.

The fused space model construction unit 3 is configured to fuse the volume element model, the lithology model and the grade model, so as to obtain a fused space model containing multi-source information of the sandstone reservoir.

The initial well spacing determination and drilling engineering addition unit 4 is configured to determine an initial well spacing according to a ratio of a thickness of an ore body to a thickness of an ore-bearing layer and a permeability coefficient of the sandstone reservoir, and add drilling engineering on the fused space model according to the initial well spacing; where the drilling engineering includes a pump well and an injection well.

The filter parameter setting unit 5 is configured to set filter parameters of the pump well and the injection well on the fused space model according to a position and a thickness of the ore body in the target mining region; where the filter parameters include an opening position and a length of a filter.

The solute particle transport simulation computation, statistical analysis and well spacing related parameter computation unit 6 is configured to carry out solute particle transport simulation computation on the injection well and the pump well, carry out statistical analysis on solute particle transport simulation computation results, and compute well spacing related parameters according to statistical results; where the solute particle transport simulation computation results include a number of particles flowing through an ore layer, a number of particles flowing through a non-ore layer and a number of particles recovered through the pump well; and the well spacing related parameters include a particle recovery rate, an effective particle utilization rate and a dilution ratio.

The optimal well spacing determination unit 7 is configured to progressively increase the initial well spacing on the basis of the fused space model according to a set step length to obtain a current well spacing, continuously carry out solute particle transport simulation computation, stop computation until the current well spacing exceeds a set threshold, obtain a plurality of groups of well spacing related parameters, draw relation curves according to the plurality of groups of well spacing related parameters, and determine an optimal well spacing according to the relation curves.

### Particular Embodiments

Technical solutions of the present disclosure will be further described below in combination with particular embodiments.

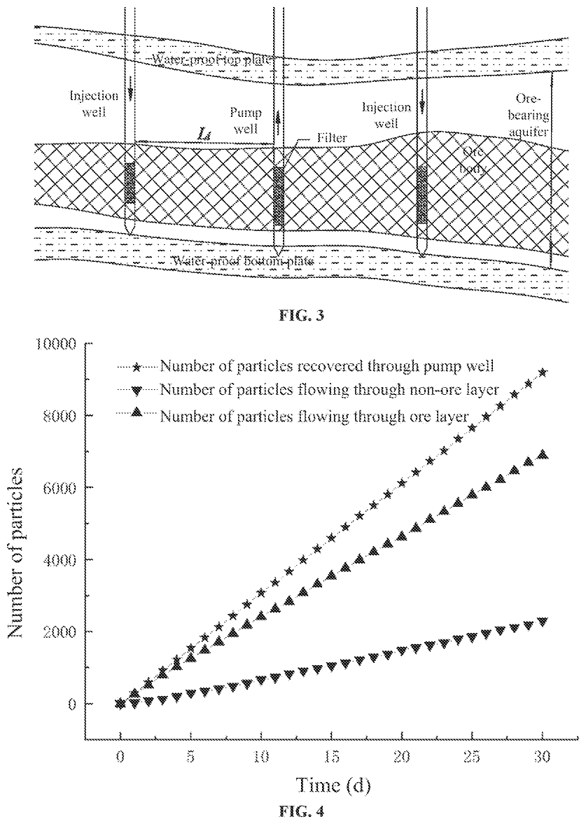

In a certain section of a high-permeability sandstone-type uranium deposit in the erlian basin, an ore-bearing layer has a K=5 m/d-12 m/d, with an average of about 7 m/d, the ore-bearing layer has an average thickness of about 25 m, an ore body has a thickness of about 8 m-14 m, a ratio of the thickness of the ore body to the thickness of the ore-bearing layer is about 1:2, and the ore body basically has 1 layer, is simple in shape and is developed near a bottom plate, as shown in FIG. 3.

According to a deployed 40-m five-spot development well and logging data thereof, a refined three-dimensional geological model of a sandstone reservoir of a target mining region is constructed. On the basis of this model, filter arrangement is optimized first, then solute particle transport simulation computation under different well spacing conditions is carried out, statistical analysis is carried out, and a curve graph is drawn.

(1) Optimization of Filter Arrangement

Under the condition of a 40-m well spacing, a filter penetrates an ore layer (a length of the filter is equal to a thickness of an ore body), or a filter is arranged according to a restrictive solution of the present disclosure (a length of a filter of a pump well is 0.8 time a thickness of an ore body, and a length of a filter of an injection well is 0.6 time the thickness of the ore body), 5000 particles are injected into each of two diagonal injection wells, and solute particle transport simulation computation is carried out for 30 d (d represents days). It can be seen from an example that optimization of a setting of a length of a filter is beneficial to reduction of dilution. Under the condition that a filter penetrates an ore layer, a particle recovery rate of a pump well is 91.91%, an effective particle utilization rate is 75.02%, and a dilution ratio is 24.98%, with statistical results seen in FIG. 4. Under the condition that a filter is arranged according to a restrictive solution, a particle recovery rate of a pump well is 86.33%, an effective particle utilization rate is 98.47%, and a dilution ratio is 1.53%, with statistical results seen in FIG. 5.

(2) Determination of Reasonable Well Spacing

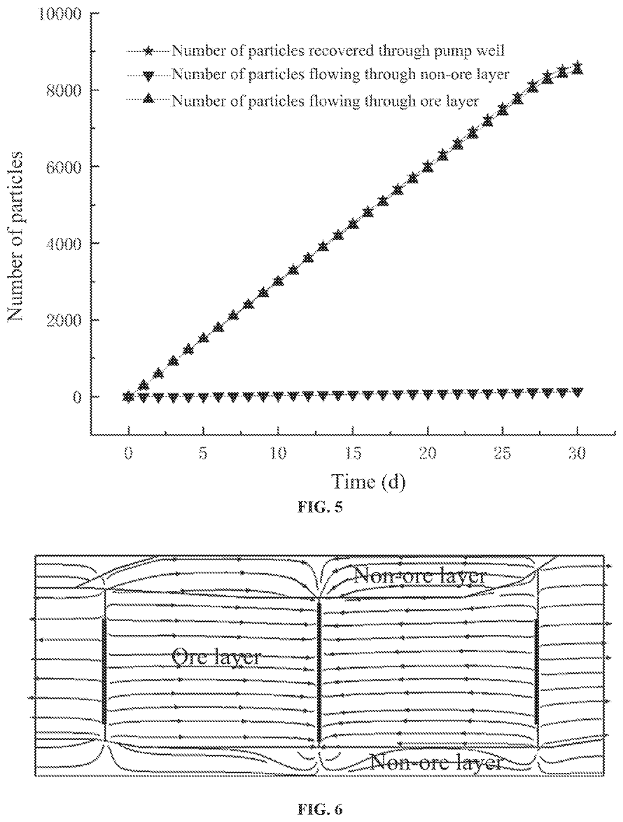

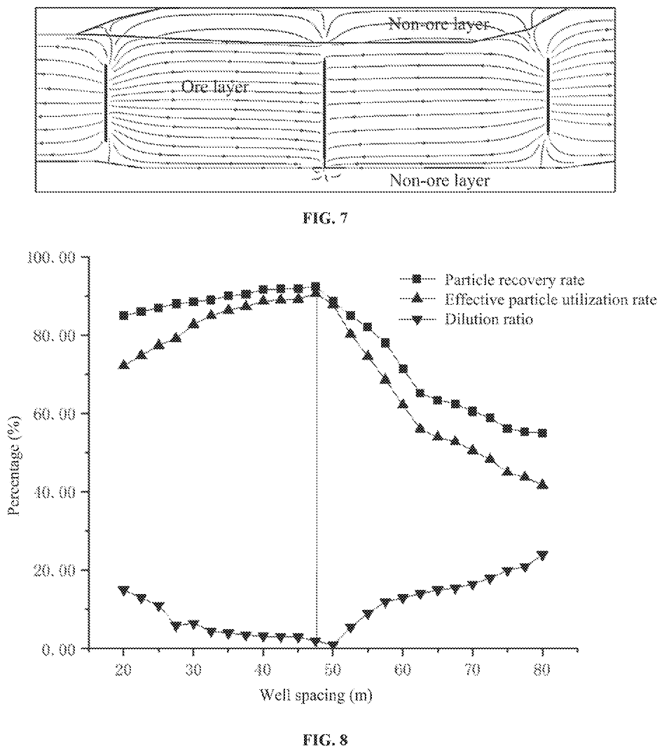

According to the solution of the present disclosure, on the basis of a three-dimensional geological model in an embodiment, according to a defined filter length setting solution, a well spacing is progressively increased by taking 2.5 m as a step length from L₀-20 m, solute particle transport simulation is carried out for 30 d, a number of particles released through an injection well is 5000, and a permeation situation of “2 injection and 1 pump” is researched from a profile, and computation is completed w % ben Lₘₐₓ=80 m. Flow field simulation diagrams in the cases of a short well spacing and a long well spacing are shown in FIGS. 6 and 7. FIGS. 6 and 7 are sectional views, in which hydraulic flow lines between pump and injection boreholes are simulated, black lines represent filters, and relative positions relative to an ore body and lengths of the filters may be seen.

Each step length is taken as an individual model, statistical analysis is carried out on computation results of 24 models, corresponding particle recovery rates (B1ᵢ), effective particle utilization rates (B2ᵢ) and dilution ratios (B3ᵢ) under the conditions of 24 groups of well spacings are output, and relation curves are drawn, as shown in FIG. 8.

Under the condition that an inflection point of the curve is Lᵢ=47.5 m, a particle recovery rate is 92.50%, an effective particle utilization rate is 90.65%, a dilution ratio is 2.00%, and a reasonable well spacing in the embodiment is 47.5 m. An economical well spacing acceptable for actual production may be extended to 52.5 m. If mining intensity and output of a mining region are considered, 40 m-45 m is also a reasonable range. For this embodiment, a well spacing of 25 m-35 m is commonly used, which is obviously not an economically-reasonable well spacing.

The embodiment is also suitable for determining a reasonable well spacing for in-situ leaching mining of a high-permeability sandstone-type copper deposit.

Beneficial effects of the present disclosure: during in-situ leaching development of a high-permeability sandstone-type uranium/copper ore body, pump and injection drilling engineering is arranged with a well spacing as large as possible, such that a number of pump and injection boreholes is reduced, and investment of drilling engineering for in-situ leaching development of the ore body and power consumption of pump and injection are greatly reduced. By combining a restrictive filter arrangement solution capable of reducing ineffective leaching, under the condition of large-well-spacing development, an effective utilization rate of a leaching agent is improved, consumption of the leaching agent by non-ore surrounding rocks and dilution of a leachate are reduced, a uranium/copper concentration of the leachate is higher on a transport path from an injection well to a pump well, consumption of hydrometallurgical raw materials and chemical reagents is reduced, and low-cost development of a high-permeability ore body is facilitated.

Each embodiment in the description is described in a progressive mode, each embodiment focuses on differences from other embodiments, and references can be made to each other for the same and similar parts between embodiments. Since the system disclosed in an embodiment corresponds to the method disclosed in an embodiment, the description is relatively simple, and for related contents, references can be made to the description of the method.

Particular examples are used herein for illustration of principles and implementation modes of the present disclosure. The descriptions of the above embodiments are merely used for assisting in understanding the method of the present disclosure and its core ideas. In addition, those of ordinary skill in the art can make various modifications in terms of particular implementation modes and the scope of application in accordance with the ideas of the present disclosure. In conclusion, the content of the description shall not be construed as limitations to the present disclosure.

What is claimed is:

1. A method for determining a well spacing for in-situ leaching mining of a high-permeability sandstone-type uranium/copper deposit, comprising:
obtaining borehole data of a sandstone-type deposit, and constructing a refined three-dimensional geological model of a sandstone reservoir of a target mining region according to the borehole data; wherein the borehole data comprises borehole coordinates, a borehole depth, ore body lithology division information and ore body grade information;
discretizing the target mining region into a regular cuboid set in a three-dimensional space, so as to construct a spatially-discretized volume element model of the sandstone reservoir; setting lithology of each regular cuboid under the constraint of the refined three-dimensional geological model of the sandstone reservoir, so as to determine a lithology model of the sandstone reservoir; and determining a uranium/copper grade of each regular cuboid according to the lithology of each regular cuboid, so as to construct a grade model of uranium/copper in a sandstone reservoir space;
fusing the volume element model, the lithology model and the grade model, so as to obtain a fused space model containing multi-source information of the sandstone reservoir;
determining an initial well spacing according to a ratio of a thickness of an ore body to a thickness of an ore-bearing layer and a permeability coefficient of the sandstone reservoir, and adding drilling engineering on the fused space model according to the initial well spacing;
wherein the drilling engineering comprises a pump well and an injection well;
setting filter parameters of the pump well and the injection well on the fused space model according to a position and a thickness of the ore body in the target mining region; wherein the filter parameters comprise an opening position and a length of a filter;
carrying out solute particle transport simulation computation on the injection well and the pump well, carrying out statistical analysis on solute particle transport simulation computation results, and computing well spacing related parameters according to statistical results; wherein the solute particle transport simulation computation results comprise a number of particles flowing through an ore layer, a number of particles flowing through a non-ore layer and a number of particles recovered through the pump well; and the well spacing related parameters comprise a particle recovery rate, an effective particle utilization rate and a dilution ratio; and
progressively increasing the initial well spacing on the basis of the fused space model according to a set step length to obtain a current well spacing, continuously carrying out solute particle transport simulation computation, stopping computation until the current well spacing exceeds a set threshold, obtaining a plurality of groups of well spacing related parameters, drawing relation curves according to the plurality of groups of well spacing related parameters, and determining an optimal well spacing according to the relation curves.

2. The method for determining a well spacing for in-situ leaching mining of a high-permeability sandstone-type uranium/copper deposit according to claim 1, wherein the obtaining borehole data of a sandstone-type deposit, and the constructing a refined three-dimensional geological model of a sandstone reservoir of a target mining region according to the borehole data specifically comprise:
preprocessing the borehole data, and constructing the refined three-dimensional geological model of the sandstone reservoir of the target mining region through an implicit modeling method based on a mathematical interpolation.

3. The method for determining a well spacing for in-situ leaching mining of a high-permeability sandstone-type uranium/copper deposit according to claim 1, wherein the determining an initial well spacing according to a ratio of a thickness of an ore body to a thickness of an ore-bearing layer and a permeability coefficient of the sandstone reservoir specifically comprises:
setting L₀=15 m under the conditions of K=1 m/d-5 m/d and P<1:3; and
setting L₀=20 m under the condition of K≥5 m/d or P>1:3; wherein
K is the permeability coefficient of the sandstone reservoir, P is the ratio of the thickness of the ore body to the thickness of the ore-bearing layer, and L₀ is the initial well spacing.

4. The method for determining a well spacing for in-situ leaching mining of a high-permeability sandstone-type uranium/copper deposit according to claim 1, wherein the setting filter parameters of the pump well and the injection well on the fused space model according to a position and a thickness of the ore body in the target mining region specifically comprises:
setting, under the condition that the ore body has a thickness greater than 10 m, positions of filters of the pump well and the injection well on the basis of a central position of the ore body, a length of the filter of the pump well 0.8 time the thickness of the ore body, and a length of the filter of the injection well 0.6 time the thickness of the ore body; and
setting, under the condition that the ore body has a thickness less than 10 m, positions of filters of the pump well and the injection well on the basis of a central position of the ore body, a length of the filter of the pump well 0.9 time the thickness of the ore body and not less than 4 m, and a length of the filter of the injection well 0.6 time the thickness of the ore body and not less than 3 m.

5. The method for determining a well spacing for in-situ leaching mining of a high-permeability sandstone-type uranium/copper deposit according to claim 1, wherein the carrying out solute particle transport simulation computation on the injection well and the pump well specifically comprises:
setting a flow rate of the pump well, a flow rate of the injection well, a total number of particles injected through the injection well and a number of days of simulation computation on the basis of permeability and groundwater pressure-bearing performance of the target mining region, so as to complete solute particle transport simulation computation.

6. The method for determining a well spacing for in-situ leaching mining of a high-permeability sandstone-type uranium/copper deposit according to claim 1, wherein the computing well spacing related parameters according to statistical results specifically comprises:
computing a ratio of a number of particles recovered through the pump well to a total number of particles injected through the injection well, so as to obtain the particle recovery rate;
computing a ratio of a number of particles flowing through the ore layer to a total number of particles injected through the injection well, so as to obtain the effective particle utilization rate; and
computing a ratio of a number of particles flowing through the non-ore layer to a number of particles recovered through the pump well, so as to obtain the dilution ratio.

7. A system for determining a well spacing for in-situ leaching mining of a high-permeability sandstone-type uranium/copper deposit, comprising:
a data obtainment and refined three-dimensional geological model construction unit configured to obtain borehole data of a sandstone-type deposit, and construct a refined three-dimensional geological model of a sandstone reservoir of a target mining region according to the borehole data; wherein the borehole data comprises borehole coordinates, a borehole depth, ore body lithology division information and ore body grade information;
a volume element model, lithology model and grade model construction unit configured to discretize the target mining region into a regular cuboid set in a three-dimensional space, so as to construct a spatially-discretized volume element model of the sandstone reservoir; set lithology of each regular cuboid under the constraint of the refined three-dimensional geological model of the sandstone reservoir, so as to determine a lithology model of the sandstone reservoir; and
determine a uranium/copper grade of each regular cuboid according to the lithology of each regular cuboid, so as to construct a grade model of uranium/copper in a sandstone reservoir space;
a fused space model construction unit configured to fuse the volume element model, the lithology model and the grade model, so as to obtain a fused space model containing multi-source information of the sandstone reservoir;
an initial well spacing determination and drilling engineering addition unit configured to determine an initial well spacing according to a ratio of a thickness of an ore body to a thickness of an ore-bearing layer and a permeability coefficient of the sandstone reservoir, and add drilling engineering on the fused space model according to the initial well spacing; wherein the drilling engineering comprises a pump well and an injection well;
a filter parameter setting unit configured to set filter parameters of the pump well and the injection well on the fused space model according to a position and a thickness of the ore body in the target mining region; wherein the filter parameters comprise an opening position and a length of a filter;
a solute particle transport simulation computation, statistical analysis and well spacing related parameter computation unit configured to carry out solute particle transport simulation computation on the injection well and the pump well, carry out statistical analysis on solute particle transport simulation computation results, and compute well spacing related parameters according to statistical results; wherein the solute particle transport simulation computation results comprise a number of particles flowing through an ore layer, a number of particles flowing through a non-ore layer and a number of particles recovered through the pump well; and the well spacing related parameters comprise a particle recovery rate, an effective particle utilization rate and a dilution ratio; and
an optimal well spacing determination unit configured to progressively increase the initial well spacing on the basis of the fused space model according to a set step length to obtain a current well spacing, continuously carry out solute particle transport simulation computation, stop computation until the current well spacing exceeds a set threshold, obtain a plurality of groups of well spacing related parameters, draw relation curves according to the plurality of groups of well spacing related parameters, and determine an optimal well spacing according to the relation curves.
